(19) United States
(12) Patent Application Publication
(10) Pub. No.: US 2003/0159996 A1
(43) Pub. Date: Aug. 28, 2003

(54) Process for adsorption of organic compounds, and adsorbents of pulverulent rubber

(75) Inventors: Uwe Ernst, Marl (DE); Udo Goerl, Recklinghausen (DE); Martin Kuge, Maintal (DE); Andreas Karau, Herzogenrath (DE); Reinhard Stober, Hasselroth (DE); Herbert Gerdau, Haltern (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ADSOCA AG, Recklinghausen (DE)

(21) Appl. No.: 10/397,199

(22) Filed: Mar. 27, 2003

Related U.S. Application Data
(62) Division of application No. 09/580,526, filed on May 30, 2000.

(30) Foreign Application Priority Data
May 27, 1999 (DE) DE 19924367.0

(51) Int. Cl. B01J 20/22; B01D 15/00

(52) U.S. Cl. 210/660; 502/401

(57) ABSTRACT

The present invention provides an adsorbent, that includes a pulverulent rubber, which contains at least one filler selected from the group including natural filler, synthetic filler, organic filler, inorganic filler, and mixtures thereof. Another embodiment of the invention relates to an article or apparatus selected from the group including a cushion, hose, suction boom, stationary bed column, suspension reactor, and fluidized bed reactor, that contain the above-noted adsorbent. Another embodiment of the invention provides a process, that includes adsorbing at least one organic compound with the above-noted adsorbent. The present invention is a readily usable and effective adsorbent, and has a high capacity, permits an efficient mass transport in the individual adsorbent particles, and has a resistance to fouling by adsorption of higher molecular weight substances or by swelling processes, and is resistant to being wetted by water and to coadsorption of water. The present invention is particularly effective for the absorption of organic compounds such as oils suspended in water, whether they are heavy or light oils.

### BACKGROUND OF THE INVENTION

1. Field of the Invention

The invention relates to a process for the adsorption of organic compounds from an aqueous environment, in which process there is used as adsorbent pulverulent rubber (rubber powder, powdered rubber) obtained by precipitation from suspensions or solutions containing filler and rubber, and to the absorbents.

2. Discussion of the Background

Adsorptive processes are now widely used for conditioning process solutions, for recovery of valuable substances from production solutions, and for treatment of exhaust air and waste water. Since the requirements imposed on purity of production solutions, on recovery of valuable substances and on permissible exhaust-air emissions and waste-water pollution are becoming increasingly more stringent, continuous further development and new development of existing adsorption technologies are needed.

The suitability of adsorptive processes depends upon the absorber properties, such as selectivity, adsorption capacity, limitation of mass transport and useful life of the adsorber.

For adsorption from an aqueous phase, conventional adsorbents based primarily upon activated carbon, polymers, and inorganic absorbents are now used. Activated carbon is a highly porous, active carbon structure, which contains mainly carbon and small proportions of chemically bound oxygen and hydrogen. Activated carbon is characterized by extremely large specific surface areas, with values in the 500 to 1500 m²/g range. The pore structure includes mainly micropores and macropores, and this is why activated carbon adsorbs molecules with molecular weight of less than 200 daltons particularly well. The specific total pore volume of activated carbon generally ranges from 1 to 1.5 ml/g.

A disadvantage of activated carbon, however, is that its surface exhibits extremely hydrophilic behavior, and this has undesirable effects on its adsorption capability.

When the surface of activated carbon is wetted with water, the adsorption capacity for organic nonpolar molecules is reduced. Furthermore, the maximum possible size of molecules that can be adsorbed on activated carbon is limited by the micropores and submicropores. Modern alternatives to activated carbon are macroporous and microporous polymer adsorbers containing, for example, styrenedivinyl copolymers with specific surface areas of between 400 and 1400 m²/g. Depending on the polymer and surface modification, these polymers exhibit either hydrophobic or hydrophilic behavior, although the molecular weights that can be optimally adsorbed are frequently less than 1000 daltons.

Accordingly, there remains a need for a readily usable and effective adsorbent.

### SUMMARY OF THE INVENTION

Acccordingly, one object of the invention is to provide a readily usable and effective adsorbent.

Another object of the invention is to provide an absorbent having a high capacity.

Another object of the invention is to provide an absorbent that permits an efficient mass transport in the individual adsorbent particles and a resistance to fouling by adsorption of higher molecular weight substances or by swelling processes.

Another object of the invention is to provide an absorbent that is effective for the absorption of organic compounds.

Another object of the invention is to provide an absorbent having a resistance to being wetted by water and to coadsorption of water.

Another object of the invention is to provide an absorbent that is effective for adsorption of oils suspended in water, whether they are heavy or light oils.

These and other objects have been achieved by the present invention, the first embodiment of which provides an adsorbent, that includes:

a pulverulent rubber, which contains at least one filler selected from the group including natural filler, synthetic filler, organic filler, inorganic filler, and mixtures thereof.

Another embodiment of the invention relates to an article or apparatus selected from the group including a cushion, hose, suction boom, stationary bed column, suspension reactor, and fluidized bed reactor, that contain the above-noted adsorbent.

Another embodiment of the invention provides a process, that includes:

adsorbing at least one organic compound with the above-noted adsorbent.

### BRIEF DESCRIPTION OF THE FIGURES

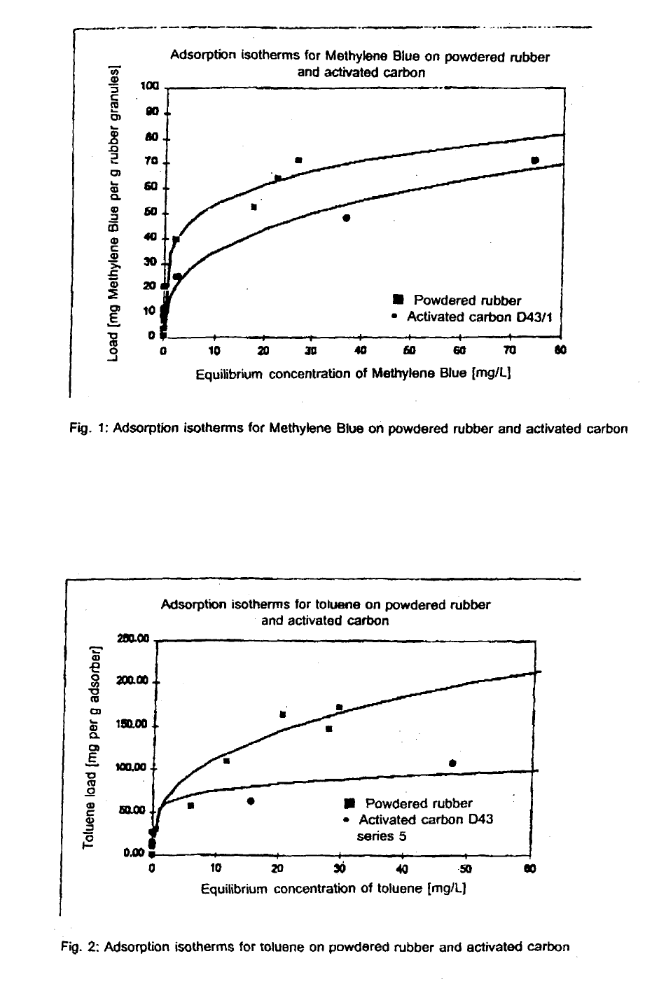

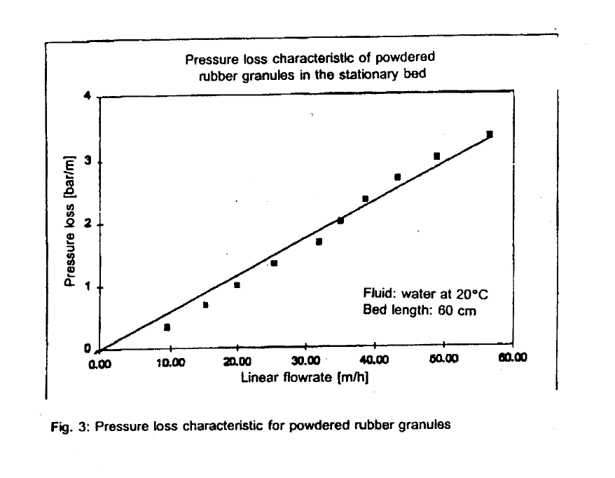

A more complete appreciation of the invention and many of the attendant advantages thereof will be readily obtained as the same becomes better understood by reference to the following detailed description when considered in connection with the accompanying drawings, wherein FIG. 1 shows adsorption isotherms for methylene blue on powdered rubber and activated carbon; FIG. 2 shows adsorption isotherms for toluene on powdered rubber and activated carbon; and FIG. 3 shows pressure loss characterstics of powdered rubber in a stationary bed.

### DETAILED DESCRIPTION OF THE INVENTION

Various other objects, features and attendant advantages of the present invention will be more fully appreciated as the same becomes better understood from the following detailed description of the preferred embodiments of the invention.

Whereas activated carbon and polymer adsorbers bind molecules adsorptively almost exclusively by virtue of their large surface, the advantages of the rubber powder used according to the invention lie in the combination of adsorption properties imparted by the structure and by the large surface of the fillers with the absorption properties imparted by the lipophilic latex matrix.

Further advantages of this material compared with those already available on the market are the high capacities and the high proportion of macropores, which on the one hand permit efficient mass transport in the individual particles and at the same time reduce the probability that the pore structure will be fouled by adsorption of higher molecular weight substances or by swelling processes. On the other hand, the wetting of the adsorber with water and thus the coadsorption of water is reduced by virtue of the hydrophobicity of the polymer.

This problem occurs in particular during the adsorption of oils suspended in water, whether they are heavy or light oils.

The subject matter of the invention preferably includes absorbents for organic compounds from an aqueous environment, which adsorbents include a pulverulent rubber, which contains natural or synthetic, organic or inorganic fillers in a proportion of 100 to 5000, preferably 100 to 3000 phr, individually or in combination.

Preferably, in the absorbent of the present invention, the filler constituent is bound permanently to the rubber matrix.

In the adsorbent, the rubber constituent and one or more fillers are present in homogeneous distribution.

Preferable adsorbents include rubber powders containing one or more oxide-type or preferably silicate type filler(s), especially a precipitated or pyrogenic silica gel in a proportion of 100 phr to 5000 phr in the case of a synthetic filler of this type, or especially in a proportion of 100 phr to 3000 phr in the case of a natural filler, the surface of which is generally modified with one or more organosilicon compounds of the general formulas

{R¹ₙ(RO)₃₋ₙSi-(Alk)ₘ-(Ar)ₚ}_{q} (I)

R¹ₙ(RO)₃₋ₙSi-(Alkyl) (II)

or

R¹ₙ(RO)₃₋ₙSi-(Alkenyl) (III)

wherein there are denoted by

B: SCN, —SH, —Cl, —NH₂ (when q=1) or —Sₓ— (when q=2)

R and R¹: a branched or nonbranched alkyl group with 1 to 4 carbon atoms or the phenyl group; all R and R¹ groups may have the same or different meanings, preferably an alkyl group,

R: a branched or nonbranched C₁ to C₄ alkyl or C₁ to C₄ alkoxy group,

n: 0; 1 or 2,

Alk: a divalent straight-chain or branched hydrocarbon group with 1 to 6 carbon atoms,

m: 0 or 1

Ar: an arylene group with 6 to 12 C atoms

p: 0 or 1, with the proviso that p, m and n are not simultaneously equal to 0,

x: a number from 2 to 8,

Alkyl: a monovalent straight-chain or branched saturated hydrocarbon group with 1 to 20 carbon atoms, preferably 2 to 8 carbon atoms,

Alkenyl: a monovalent straight-chain or branched unsaturated hydrocarbon group with 2 to 20 carbon atoms, preferably 2 to 8 carbon atoms, and/or carbon blacks in a proportion of 100 phr to 5000 phr, the total proportion of fillers not exceeding 5000 phr individually or in combination.

Preferable rubber types, individually or in mixtures with one another, include natural rubber, emulsion SBR with a styrene proportion of 10 to 50%, butyl-acrylonitrile rubber, butyl rubbers, terpolymers of ethylene, propylene (EPM) and nonconjugated dienes (EPDM), butadiene rubbers, SBR synthesized by the solution polymerization method and having styrene contents of 10 to 25% as well as contents of 1,2-vinyl constituents from 20 to 55%, and isoprene rubbers, especially 3,4-polyisoprene.

Other preferable rubbers include the following elastomers, individually or in mixtures: carboxyl rubbers, epoxy rubbers, trans-polypentenamers, halogenated butyl rubbers, 2-chlorobutadiene rubbers, ethylene/vinyl acetate copolymers, epichlorohydrins and possibly even chemically modified natural rubber, such as epoxy-modified types.

Preferale fillers, which can be used individually or in combination with one another, include the carbon blacks known from rubber processing, pigment blacks, especially of rubber flour obtained from recycling processes, activated carbon, white fillers of synthetic nature, such as precipitated or pyrogenic silica gels, zeolites, sodium aluminosilicates or natural fillers, such as siliceous chalk, clays, gypsum or cement.

Also suitable are the powders obtained in the thermal conditioning of lacquer sludges (Salemer®).

Especially suitable are carbon blacks of the type generally used in rubber processing or as pigments, or even carbon blacks whose surface has been modified by oxidative posttreatment. These include furnace blacks as well as gas and flame blacks with an iodine absorption number of 5 to 1200 m²/g, especially 25 to 1075 m²/g, a CTAB number of 15 to 700 m²/g, a DBP adsorption of 30 to 400 ml/100 g and a 24 M4 DBP number of 50 to 400 ml/100 g in a proportion of 50 to 5000 parts, especially 200 to 2000 parts per 100 parts of rubber.

Also suitable are the precipitated silica gels known from the rubber industry, as well as pyrogenic silica gels.

These generally have an N₂ surface determined by the known BET method of 35 to 1100 m²/g, especially 100 to 1000 m²/g, a CTAB surface of 30 to 500 m²/g, a DBP number of 150 to 400 ml/100 g. The product used according to the invention preferably contains these silica gels in a proportion of 50 to 3000 parts, especially 200 to 2000 parts per 100 parts of rubber.

In the case of fillers such as rubber flour, activated carbon, sodium aluminosilicates, zeolites or white natural fillers such as clays, cement, gypsum or siliceous chalk with an N₂ surface of 2 to 35 m²/g, these are incorporated in a proportion of 50 to 3000 parts per 100 parts of rubber.

Filled rubber powders which contain silica gels, rubber flour, activated carbon, sodium aluminosilicates, zeolites, cement, gypsum and carbon black are also preferable. Most preferably, these are used as mixtures.

Preferably, the total proportion of filler amounts in this case to 50 to 5000 parts of filler per 100 parts of rubber.

Preferably there are used fillers with a large specific surface. Particularly suitable are carbon blacks, which have large adsorption capacities by virtue of their large specific surface. The adsorption capacity becomes better with increasing surface and structure of the carbon black. The surface can be modified with oxygen-containing functional groups and the adsorption behavior of the carbon blacks influenced by oxidative post/treatment solvents, polymers, etc. are adsorbed to different extents depending on how the surfaces are modified. The specific surface of the absorber can be varied via the ratio of filler used to polymer and also via the properties of the filler (for example, primary particle diameter, filler structure). The proportion of filler in the rubber powder used according to the invention preferably ranges from 40 to 98 wt %, especially 66 to 96 wt %.

Filler particles are intimately bound in the surface to a degree which preferably depends on the filling ratio of the rubber powder, and so the particles made by the new process do not stick to one another even under pressure, for example when several bags rest one upon the other.

The absorbents used according to the invention and including filled, finely divided rubbers (rubber powders) are preferably obtained by precipitation from aqueous mixtures containing the fillers, preferably silicate-type fillers and/or carbon blacks, in the form of a suspension, an aqueous emulsion of a rubber (polymer) or a rubber solution, by addition of water-soluble salts of a metal selected from Groups Ia, IIb, IIIa and VIII of the Periodic Table, the entire contents of which is hereby incorporated by reference.

The process is preferably characterized in that:

a) a filler suspension with a suspension density between 0.5 and 10%, especially between 5 and 7% relative to the solid, is first prepared by stirring the filler together with water, the filler being in particular a silicate-type compound and/or carbon black, the solid particles being ground down (deagglomerated) beforehand if necessary by means of a suitable mill, and compounds such as polyhydric alcohols or polyvalent amines which form hydrogen bonds also being added to the suspension if necessary in proportions of 0.5 to 10 parts per 100 parts of the filler, and the suspension being heated if necessary to temperatures in the range between 25 and 95° C.,

b) and then, when the suspension contains silicate-type fillers, one or more organosilicon compound(s) according to formulas (I) to (III), containing at least one alkoxy group, dissolved in water or emulsified in water directly or if necessary in the presence of a surfactant, is or are mixed by stirring with the cited aqueous suspension of this filler or a mixture thereof with a carbon black at a temperature of 10 to 60° C., preferably at room temperature,

c) the suspension prepared in this way is mixed with the polymer latex, the polymer emulsion or the polymer solution, the pH of this mixture is lowered by means of an acid or of the aqueous solution of one of the aforesaid salts, especially a Lewis acid, to a pH of 7 to 4, preferably between 6.5 and 4.5, and the rubber present in the mixture is precipitated together with the fillers, which have been modified if necessary by the said organosilicon compounds,

d) the precipitated filled rubber powder is separated by procedures known in themselves and if necessary washed to acid-free condition,

e) the filler obtained in this way is dried and if necessary granulated.

It is also possible to make absorbents of this type by using silicate-type fillers modified beforehand with organosilicon compounds according to formulas (I) to (III), thus eliminating step b) of the cited process.

If a filler proportion in the 100 to 500 phr range is desired, a two-stage process for lowering the pH is preferable.

In this case the pH is generally adjusted within the range of 5.5 to 4.5 in the first step and to about 3.2 in the second step. During this procedure, the filler is also added in finely divided form to the two pH steps.

As the fillers there are used the aforesaid carbon blacks, preferably in finely divided (fluffy) form, generally with a mean particle diameter of 1 to 9 μm, preferably 1 to 8 μm, before they are suspended. This facilitates dispersion, and so aqueous suspensions with filler particles having a mean particle diameter of much smaller than 10 μm are obtained without high energy consumption. The precipitated silica gel can be used advantageously in the form of a filter cake that has been washed to salt-free condition.

Suitable metal salts are those of elements of Groups Ia, IIb, IIIa and VIII of the Periodic Table. This group classification corresponds to the old IUPAC Recommendation (see Periodic Table, Verlag Chemie, Weinheim, 1985, the entire contents of which are hereby incorporated by reference). Preferable representatives are magnesium chloride, zinc sulfate, aluminum chloride, aluminum sulfate, iron chloride, iron sulfate, cobalt nitrate and nickel sulfate, the aluminum salts being preferred. Aluminum sulfate is especially preferred.

The salts are used in proportions of 0.1 to 6.5 parts by weight per 100 parts by weight of rubber. Acids which are suitable and if necessary are used for adjusting the specified pH are primarily inorganic acids such as sulfuric acid, phosphoric acid and hydrochloric acid, sulfuric acid being especially preferred. Carboxylic acids such as formic and acetic acids, however, can also be used.

The precipitated rubber powder is advantageously separated by means of a centrifuge and then dried to a residual water content which in general is s 1%, especially in a fluidized-bed dryer.

The rubber powders made in this way generally contain no micropores but mainly mesopores (2 to 30 nm) and macropores (>30 nm). The percentage pore distribution between mesopores and macropores is generally between 1:2.5 and 1:22.

Depending on the filler used, the total pore volume then ranges from 1.0 to 4 ml/g, especially 1.5 to 3 ml/g. The particle-size range generally extends from 0.4 to 10 mm diameter, especially 1 to 3 mm.

If the raw materials used in the powdered rubber include exclusively carbon black and latex, they can be removed almost without residue by heat treatment. This can be regarded as a further advantage compared with conventional oil binders.

Although the specific surfaces of the rubber powders are smaller, depending on the fillers present, than those of the conventionally used activated carbons, a greater equilibrium capacity is found during, for example, the adsorption of compounds from the aqueous phase with the rubber powder.

The rubber powders according to the invention are particularly suitable for the adsorption of nonpolar organic compounds which are poorly soluble in water.

The use of the absorbents according to the invention is recommended in particular when the substances to be adsorbed are present in low to medium concentrations, when the substances to be adsorbed have poor water solubility or a high octanol/water distribution coefficient, and when stringent purity requirements are imposed on the filtrate.

Particularly suitable for this application are the inventive adsorbents with a filler content of >1000 to 2000 phr.

A significant problem is pollution of bodies of water by oil spills due to shipping accidents. Whereas oil on the open sea can be recovered by oil-collection vessels, hardly any suitable techniques exist for protection of coastal regions against oil-related accidents. To an increasing extent it must be taken for granted that thousands of seabirds will die and considerable, sometimes irreversible damage will be sustained by the marine fauna and flora due to oil slicks. Usually the oil is eliminated only when the sludge has reached the beach area of the coast. Disposal companies are then hired to “plane” the beach in order to eliminate the contamination. Even today, this very laborious method of beach cleanup, to some extent still performed manually with shovels and pails, is still the, state of the art.

The oil-binding capacity of the powdered rubber can be varied in particular via the ratio of carbon black used to polymer and via the properties of the carbon black (primary particle diameter, structure) The suitability of the oil binder for special requirements (such as adsorption of light oil or heavy oil) can be adapted optimally by appropriate choice of the two components. By virtue of the surfactant properties of carbon black, the adsorption of lower molecular weight substances is also possible, thus further increasing the cleaning power of the oil binder with regard to the possible residual COD.

Inventive adsorbents with a filler content of 100 to 1000 phr, especially 200 to 800 phr, have proved particularly suitable for adsorption of oils floating on the water (oil in phase).

Use of the oil binder of the present invention on the process scale can preferably take place as follows:

In the case of tanker accidents, the oil binder is spread over the surface by helicopters or, after mixing with water, by water cannons. Powdered rubber adsorbs oil from the water surface within a short time and binds it irreversibly. From the granulated product there are produced voluminous, gummy aggregates, which can be collected easily, Even oil from emulsions can be adsorbed with powdered rubber.

Hydrocarbons and emulsions are separated by stationary-bed columns. Linear flowrates of 20 to 40 m/h can be achieved for water at a pressure loss of between 1 and 2 bar/m. The water cleaned of oil has a residual oil content of <100 ppm.

Adsorption of oil from bodies of water by cushions, hoses and suction booms filled with oil binder.

Besides spreading over the surface and the use of separation containers, it is possible to bind powdered rubber in textiles and use it in the form of self-adsorbent oil barriers, hoses and cushions for cleanup of bodies of water.

The advantages of the powdered rubber used according to the invention compared with the oil binders available on the market, such as polypropylene and cellulose, lie in the strongly oleophilic nature and the high oil-adsorption capacity (up to about 300% of its own weight), which is imparted by the large proportion of macropores in the molecule. This pore structure permits efficient mass transport in the adsorbent, irreversible binding of the oil and long useful life. Furthermore, powdered rubber is absolutely harmless for fauna and flora.

By virtue of the hydrophobicity of the polymer, moreover, wetting of the oil binder with water and thus potential coadsorption is very much reduced.

The inventive absorbents adsorb gasoline In the same way as do waxes. Thus, for example, aliphatic hydrocarbons, especially with 5 to 35 carbon atoms, or in other words molecules corresponding to about 70 to 500 daltons, can be bound.

These substances also include the lower molecular weight compounds with 5 to 8 carbon atoms (benzene, toluene, etc.).

The adsorbent of the present invention is preferably used for organic compounds emulsified, dissolved or floating in water.

Having generally described this invention, a further understanding can be obtained by reference to certain specific examples which are provided herein for purposes of illustration only and are not intended to be limiting unless otherwise specified.

### EXAMPLES

The following examples illustrate the adsorption behavior for selected lower molecular weight substances and oil on the rubber powders used according to the invention.

### Example 1

Table 1 lists the specific surface and pore-volume distribution over the various pore structures for an adsorber based on styrene-polybutadiene rubber and a carbon black with little structure. Materials of this composition do not contain any micropores but have mainly mesopores and macropores. The specific surface of 455 m²/g is smaller than that of most activated carbons. FIGS. 1 and 2 show the adsorption isotherms for Methylene Blue and toluene on powdered rubber compared with a commercially available activated carbon (D43/1, Carbochem Co.). The equilibrium capacities achievable from aqueous solutions range between 150 and 200 mg per g of adsorber for toluene and around 80 mg per g for Methylene Blue, and are much higher than for conventional activated carbon. More extensive studies have shown that this material is suitable in particular for adsorption of nonpolar substances which are poorly soluble in water (see Table 2).

Use of this adsorber on the process scale can take place in, for example, a stationary-bed column with an ascending flow. The achievable flowrate as a function of pressure loss over the column is illustrated in FIG. 3. Linear flowrates of 20 to 40 m/h in the bed can be achieved for water at pressure losses of between 1 and 2 bar/m.

TABLE 1
Summary of adsorber data

| | |
|---|---|
| Carbon black content [%] | 83 |
| Specific surface [m²/g] | 455 |
| Micropores [ml/g] | none |
| Mesopores (2-30 nm) [ml/g] | 0.7 |
| Macropores (>30 nm) [ml/g] | 3.17 |
| Total pore volume [ml/g] | 3.87 |

TABLE 2
Equilibrium capacities for various substances
to be adsorbed from the aqueous phase

| Substance to be absorbed | Equilibrium capacity at 50 mg/l | |
|---|---|---|
| Phenol | about 10 | mg/g |
| Methylene Blue | about 70 | mg/g |
| Toluene | about 180 | mg/g |

### Example 2

Oil binder that includes powdered rubber containing carbon black N339 with filling ratio of 500 phr has the following characteristic data for oil adsorption:

| | |
|---|---|
| Bulk density: | 280 g/l |
| Oil adsorption capacity: | with pressure loading 100 g product |
| | binds 213 g oil 100 ml product binds 74 |
| | ml oil |
| Oil adsorption capacity: | without pressure loading 100 g product |
| | binds 276 g oil 100 ml product binds 96 |
| | ml oil |
| Proportions capable | without oil: >95% |
| of flotation: | with oil: >95% |

The oil-retaining capacity of powdered rubber was also tested. After oil adsorption, powdered rubber no longer releases oil even under pressure loading (loading time 2 hours).

Obviously, numerous modifications and variations of the present invention are possible in light of the above teachings. It is therefore to be understood that within the scope of the appended claims, the invention may be practiced otherwise than as specifically described herein.

This application is based on German Patent Application 19924367.0 filed on May 27, 1999, and incorporated herein by reference in its entirety.

1. An adsorbent, comprising:
a pulverulent rubber, which contains at least one filler selected from the group consisting of natural filler, synthetic filler, organic filler, inorganic filler, and mixtures thereof.

2. The adsorbent according to claim 1, wherein said filler is present in an amount of 100 to 5000 phr.

3. The adsorbent according to claim 1, wherein said filler is a natural or synthetic filler selected from the group consisting of oxide filler, silicate filler, a precipitated or pyrogenic silica gel, and mixtures thereof, and wherein a surface of said filler is modified with one or more organosilicon compounds having any of the formulas (I-III):
{R¹ₙ(RO)₃₋ₙSi-(Alk)ₘ-(Ar)ₚ}_{q} (I)
R¹ₙ(RO)₃₋ₙSi-(alkyl) (II)
or
R¹ₙ(RO)₃₋ₙSi-(alkenyl) (III)
wherein:
B: —SCN, —SH, —Cl, —NH₂ (when q=1) or —Sₓ— (when q=2);
R and R¹: each independently represent a branched or nonbranched alkyl group with 1 to 4 carbon atoms or a phenyl group;
R: a branched or nonbranched C₁ to C₄ alkyl or C₁ to C₄ alkoxy group;
n: 0; 1 or 2;
Alk: a divalent straight-chain or branched hydrocarbon group with 1 to 6 carbon atoms;
m: 0 or 1;
Ar: an arylene group with 6 to 12 carbon atoms;
p: 0 or 1, with the proviso that p, m and n are not simultaneously equal to 0,;
x: a number from 2 to 8;
Alkyl: a monovalent straight-chain or branched saturated hydrocarbon group with 1 to 20 carbon atoms;
Alkenyl: a monovalent straight-chain or branched unsaturated hydrocarbon group with 2 to 20 carbon atoms;
wherein the total amount of said filler does not exceed 5000 phr individually or in combination, and wherein said filler is permanently bound with the rubber.

4. The adsorbent according to claim 1, wherein said filler is permanently bound with said rubber.

5. The adsorbent according to claim 1, characterized in that said rubber comprises SBR rubber.

6. The adsorbent according to claim 1, wherein said filler comprises carbon black in an amount of 100 to 2000 phr.

7. The adsorbent according to claim 1, wherein said filler comprises rubber flour in an amount of 100 to 3000 phr.

8. The adsorbent according to claim 1, wherein said filler comprises sodium aluminosilicate in an amount of 100 to 3000 phr.

9. The adsorbent according to claim 1, wherein said filler comprises zeolite in an amount of 100 to 3000 phr.

10. The adsorbent according to claim 1, wherein said rubber comprises said filler in a total amount of 100 to 5000 phr.

11. The adsorbent according to claim 1, wherein said rubber has a particle-size distribution of 0.4 to 10 mm and a total pore volume of 1.0 to 4 ml/g.

12. An article or apparatus selected from the group consisting of a cushion, hose, suction boom, stationary bed column, suspension reactor, and fluidized bed reactor, comprising the adsorbent according to claim 1.

13. A process, comprising:
adsorbing at least one organic compound with the adsorbent according to claim 1.

14. The process according to claim 13, wherein said organic compound is at least one selected from the group consisting of nonpolar, poorly water-soluble, water-insoluble, light oil, heavy oil, and combinations thereof.

15. The process according to claim 13, wherein said organic compound is either emulsified, dissolved, or floating in water.

16. The process according to claim 13, further comprising separating said organic compound from said adsorbent.

17. The process according to claim 13, wherein said organic compound is at least one oil selected from the group consisting of a light oil or a heavy oil, and wherein said filler is present in an amount of 100 to 1000 phr.

18. The process according to claim 13, wherein said organic compound is soluble in water, and wherein said filler is present in an amount of greater than 1000 to less than or equal to 2000 phr.

19. The process according to claim 13, wherein said adsorbent is present in an article or apparatus selected from the group consisting of cushion, hose, suction boom, stationary bed column, suspension reactor, fluidized bed reactor, and combinations thereof.

20. The process according to claim 13, comprising contacting said absorbent with water, said water being contaminated with said organic compound.
